(19) United States
(12) Patent Application Publication
(10) Pub. No.: US 2024/0259868 A1
(43) Pub. Date: Aug. 1, 2024

(54) SYSTEM, METHOD, AND NON-TRANSITORY COMPUTER-READABLE MEDIA FOR FORECASTING CAPACITY BREACHES IN A MOBILE NETWORK

(71) Applicant: Rakuten Symphony Singapore Pte. Ltd., Singapore (SG)

(72) Inventors: Nimit AGRAWAL, Indore (IN); Akash SONI, Indore (IN)

(21) Appl. No.: 17/997,658

(22) PCT Filed: Aug. 18, 2022
(86) PCT No.: PCT/US2022/040703

§ 371 Date: Nov. 1, 2022

(51) Int. Cl. H04W 28/02; H04L 41/147; H04L 47/127

(52) U.S. Cl. CPC H04W 28/0289; H04L 41/147; H04L 47/127

(57) ABSTRACT

Capacity breaches are forecast in a mobile network. A Key Performance Indicators (KPI) database is accessed to obtain KPI data associated capacity of cells in a mobile network. Based on the KPI data, critical cells and non-critical cells are identified, wherein the critical cells exhibit high utilization affecting performance, and the non-critical cells do not exhibit high utilization. For the non-critical cells, a prediction model is applied to identify at least one predetermined forecast time window associated with capacity issues associated with at least one of the non-critical cells. Based on applying the prediction model, a report is generated identifying actions to execute to address capacity issues. An action from the report is executed to configure the mobile network to address the capacity issues of the critical cells, and/or capacity issues of the non-critical cells having forecasted capacity issues within one of the predetermined forecast time windows.

### TECHNICAL FIELD

This description relates to a system, method, and non-transitory computer-readable media for forecasting capacity breaches in a mobile network.

### BACKGROUND

Mobile networks involve the installation of cells sites over an extended geographic area. As the number of users and proliferation of bandwidth intensive services, such as video and music streaming, smart devices, multi-player video gaming, etc., the capacity of particular cell sites increase and often reaches a point the user experience is negatively affected. Cells that are highly utilize lead to network performance issues, such as slower upload/download speeds, latency, and coverage issues.

Currently, due to the lack of proper network monitoring tools, network operators do not have prior notification or knowledge that capacity breaches in the network are going to happen. For example, a cell at one point in time is experiencing 50% utilization, but soon the utilization increases to 80% or 90%. Identifying and addressing these kinds of problems is difficult and time consuming.

To increase the performance and divide the load, new sites, antennas, or technology are installed blindly or after the fact. However, this is inefficient and leads to the unproductive utilization of personnel, software, and hardware resources.

### SUMMARY

In at least embodiment, a method for forecasting capacity breaches in a mobile network includes accessing a Key Performance Indicators (KPI) database to obtain KPI data associated capacity of cells in a mobile network, based on the KPI data, identifying critical cells and non-critical cells, the critical cells exhibiting high utilization affecting performance by the critical cells, and the non-critical cells not exhibiting high utilization, for the non-critical cells, applying a prediction model to identify at least one predetermined forecast time window associated with capacity issues associated with at least one of the non-critical cells, based on the applying the prediction model, generating a report identifying at least one action to execute to configure the mobile network to address at least one of capacity issues of the critical cells, or capacity issues of the non-critical cells having forecasted capacity issues within one of the predetermined forecast time windows, and executing the at least one action to configure the mobile network to address the at least one of capacity issues of the critical cells, or capacity issues of the non-critical cells having forecasted capacity issues within one of the predetermined forecast time windows.

In at least embodiment, a device for forecasting capacity breaches in a mobile network includes a memory storing computer-readable instructions; and a processor configured to execute the computer-readable instructions to access a Key Performance Indicators (KPI) database to obtain KPI data associated capacity of cells in a mobile network, based on the KPI data, identify critical cells and non-critical cells, the critical cells exhibiting high utilization affecting performance by the critical cells, and the non-critical cells not exhibiting high utilization, for the non-critical cells, apply a prediction model to identify at least one predetermined forecast time window associated with capacity issues associated with at least one of the non-critical cells, or generate a report identifying an action to execute to configure the mobile network to address at least one of capacity issues of the critical cells, or capacity issues of the non-critical cells having forecasted capacity issues within one of the predetermined forecast time windows.

In at least embodiment, a non-transitory computer-readable media having computer-readable instructions stored thereon, which when executed by a processor causes the processor to perform operations including accessing a Key Performance Indicators (KPI) database to obtain KPI data associated capacity of cells in a mobile network, based on the KPI data, identifying critical cells and non-critical cells, the critical cells exhibiting high utilization affecting performance by the critical cells, and the non-critical cells not exhibiting high utilization, for the non-critical cells, applying a prediction model to identify at least one predetermined forecast time window associated with capacity issues associated with at least one of the non-critical cells, based on the applying the prediction model, generating a report identifying at least one action to execute to configure the mobile network to address at least one of capacity issues of the critical cells, or capacity issues of the non-critical cells having forecasted capacity issues within one of the predetermined forecast time windows, and executing the at least one action to configure the mobile network to address the at least one of capacity issues of the critical cells, or capacity issues of the non-critical cells having forecasted capacity issues within one of the predetermined forecast time windows.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a mobile network according to at least one embodiment.

FIG. 2 illustrates a Key Performance Indicator (KPI) List according to at least one embodiment.

FIG. 3 illustrates Bearing And Angle Calculation according to at least one embodiment.

FIG. 4 a flowchart 400 of a method for identifying Critical Cells and Non-Critical Cells according to at least one embodiment.

FIG. 5 is a flowchart of a method for processing critical cells without prediction according to at least one embodiment.

FIG. 6 illustrates a reference table for determining how to make a forecasting decision according to at least one embodiment.

FIG. 7 a flowchart of a method for processing non-critical cells with prediction according to at least one embodiment.

FIG. 8 is a flowchart of a method for executing an action for addressing identified capacity issues according to at least one embodiment

FIG. 9 illustrates predetermined forecast windows according to at least one embodiment.

FIG. 10 illustrates a capacity planning report according to at least one embodiment.

FIG. 11 is a flowchart of a method for forecasting capacity breaches in a mobile network according to at least one embodiment.

FIG. 12 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Terms “system” and “network” in embodiments of this application are used interchangeably. “At least one” means one or more, and “a plurality of” means two or more. The term “and/or” describes an association relationship between associated objects and indicates that three relationships exist. For example, A and/or B indicate the following cases: Only A exists, both A and B exist, and only B exists, where A and B is singular or plural. The character “/” generally indicates an “or” relationship between the associated objects. “At least one of” or a similar expression thereof means any combination of items, including any combination of singular items (pieces) or plural items (pieces). For example, “at least one of A, B, and C” includes A, B, C, AB, AC, BC, or ABC, and ““at least one of A, B, or C” includes A, B, C, A and B, A and C, B and C, or A and B and C.

According to at least one embodiment, a method for forecasting capacity breaches in a mobile network includes accessing a Key Performance Indicators (KPI) database to obtain KPI data associated capacity of cells in a mobile network, based on the KPI data, identifying critical cells and non-critical cells, the critical cells exhibiting high utilization affecting performance by the critical cells, and the non-critical cells not exhibiting high utilization, for the non-critical cells, applying a prediction model to identify at least one predetermined forecast time window associated with capacity issues associated with at least one of the non-critical cells, based on the applying the prediction model, generating a report identifying at least one action to execute to configure the mobile network to address at least one of capacity issues of the critical cells, or capacity issues of the non-critical cells having forecasted capacity issues within one of the predetermined forecast time windows, and executing the at least one action to configure the mobile network to address the at least one of capacity issues of the critical cells, or capacity issues of the non-critical cells having forecasted capacity issues within one of the predetermined forecast time windows.

Advantages associated with the method for forecasting capacity breaches in a mobile network include identifying cells that are going to be critical in the near future, reducing the capacity failures and network failures due to the current capacity load, improving network performance, proactively managing highly utilized cells, and identifying potential risks in network. Forecasting network capacity breaches in the future and helps to plan network expansion to avoid network failures due to capacity breaches.

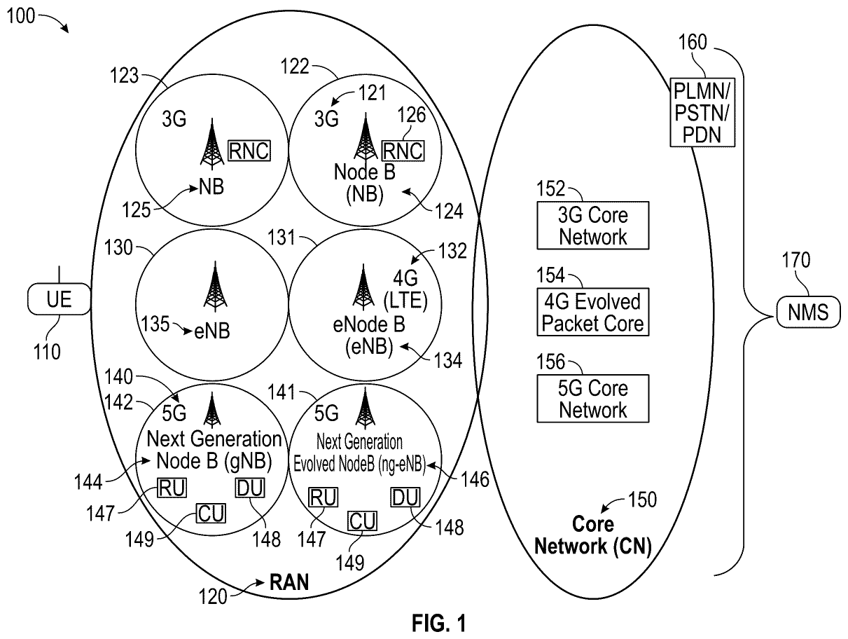

FIG. 1 illustrates a mobile network 100 according to at least one embodiment.

In FIG. 1, a mobile telecommunication network couples User Equipment (EU) 110 through Radio Access Network (RAN) 120 to a Core Network (CN) 150. RAN 120 connects individual devices, such as User Equipment (EU) 110 to other parts of a network, e.g., CN 150, through radio connections. RAN 120 is responsible for managing radio resources, including strategies and algorithms for controlling power, channel allocation and data rate.

RANs 120 have evolved over time, from 3G to 5G. For example, RANs 120 are implemented in various configurations, such as Global System for Mobile Communications (GSM) RAN (GRAN), GSM Enhanced Data Rates for GSM Evolution (EDGE) RAN (GERAN), Universal Mobile Telecommunications Service (UMTS) Terrestrial RAN (UTRAN), Evolved UMTS Terrestrial RAN (E-UTRAN), Centralized/Cloud RAN (CRAN), Virtualized RAN (VRAN), and Open RAN (ORAN).

In a 3G network 121, RAN 120 includes the base station for Cells Sites 122, 123, which is called a Node B (NB) 124, 125, and a Radio Network Controller (RNC) 126. RNC 126 controls and manages the radio transceivers in Node Bs 124, 125, as well as manages operational functions, such as handoffs, and the radio channels. The RNC 126 handles communication with the 3G Core Network 152.

In a 4G network 132, Cell Sites 130, 131 are implemented using Evolved Node Bs (eNodeBs or eNBs) 134, 135 for the radio base station. The eNodeBs 134, 135 are able to perform the radio access functions that are equivalent to the combined work that Node Bs 124, 125 and RNC do in 3G and connect to the Evolved Packet Core 154.

In a 5G network 140, Cell Sites 141, 142 are implemented using one of two types of RANs: Next Generation Node B (gNodeB) 144 and Next Generation Evolved Node B (ng-eNB) 146. The ng-eNB 146 is an enhanced version of 4G eNodeB and connects 5G UE 110 to the 5G Core Network (5GC) 156 using 4G LTE air interface. The gNB 144 allows 5G UE 110 to connect with a 5GC 156 using 5G NR air interface. The gNBs 144 and ng-eNBs 146 are interconnected by means of the Xn interface. The gNBs 144 and ng-eNBs 146 are also connected by means of the NG interfaces to the 5GC 156.

In 5G, for example, an Open RAN environment is able to be implemented wherein the RAN 120, provided by The gNBs 144 and ng-eNBs 146, is separated into the Radio Unit (RU) 147, the Distributed Unit (DU) 148, and the Centralized Unit (CU) 149. The RU 147 is where the radio frequency signals are transmitted, received, amplified, and digitized. The RU 147 is located near or integrated into, the antenna. The DU 148 and CU 149 are the computation parts of the base station, sending the digitalized radio signal into the network. The DU 148 is physically located at or near the RU 147 whereas the CU 149 is often located nearer the Core Network 150. The different interfaces associated with the Open RAN 120 include the Fronthaul (FH) that lies between the RU 147 and the DU 148, the Midhaul (MH) that lies between the DU 148 and the CU 149, and the Backhaul (BH) that lies between the CU 149 and the Core Network 150.

Core Network (CN) 150 connects RAN 120 to networks 160, such as a Public Landline Mobile Network (PLMN), a Public Switched Telephone Network (PSTN) and a Packet Data Network (PDN). CN 150 provides high-level traffic aggregation, routing, call control/switching, user authentication and charging. The 3G CN 152 involves two different domains: circuit switched elements and packet switched elements. The 4G Evolved Packet Core (EPC) 154 includes four main network elements: the Serving Gateway (S-GW), the packet data network (PDN) Gateway (P-GW), the mobility management entity (MME), and the Home Subscriber Server (HSS). The S-GW routes and forwards data packets from the UE and acts as the mobility anchor during inter-eNodeB handovers. The P-GW acts as an ingress and egress point to the EPC from a PDN (Packet Data Network) such as the Internet. The MME manages UE access network and mobility, as well as establishing the bearer path for User Equipment (UE). The MME is also concerned with the bearer activation/deactivation process. The HSS is the master database for a given subscriber, acting as a central repository of information for network nodes. Subscriber related information held by the HSS includes user identification, security, location, and subscription profile. The EPC is connected to the external networks, which includes the IP Multimedia Core Network Subsystem (IMS). 5GC 156 supports new network functions (NFs) associated with the packet core and user data management domains. 5GC 156 provides a decomposed network architecture with the introduction of a service-based interface (SBI), and control plane and user plane separation (CUPS). 5GC decomposes the 4G MME into an Access and Mobility Management Function (AMF) and a Session Management Function (SMF). The AMF receives connection and session related information from the UE, but is responsible for handling connection and mobility management tasks. Messages related to session management are forwarded to the SMF.

The network is managed by the network management system (NMS) 170, which provides several network management functionalities. According to at least one embodiment, the NMS provides forecasting of capacity breaches in the mobile network 100. There is a maximum number of users that may be accommodated by the mobile network 100 before either the quality or performance of the mobile network 100 is negatively impacted. The carrying capacity of a mobile network 100 is the total amount of data or voice traffic that a cell site, e.g., Cell Sites 122, 123, 130, 131, 141, 142, of the mobile network 100 is able to transfer to and from customers. Wireless data are carried by modulating radio waves. The quantity of waves (or amount of spectrum) a wireless system is allowed to modulate each second is called its bandwidth, and is measured in hertz (Hz). Everything else equal, a signal with a higher bandwidth (i.e., more Hz) can carry more data per second than a signal of lower bandwidth (i.e., less Hz). The total amount of data that a cell site transfers over a given period of time relates to the rate at which Cell Sites 122, 123, 130, 131, 141, 142 transfer data bytes. All things equal, a faster cell site will transfer more bytes than a slower cell site. Rates of data transfer are measured in terms of bits per second (bps).

As the number of users increases, so does the amount of traffic that occurs in a given period of time. As a consequence, Cell Sites 122, 123, 130, 131, 141, 142 progressively becomes more and more congested. As a result, the channels of Cell Sites 122, 123, 130, 131, 141, 142 will continue to diminish. According to at least one embodiment, NMS 170 identifies current critical cells and forecasts when other cells raise issues that are to be addressed.

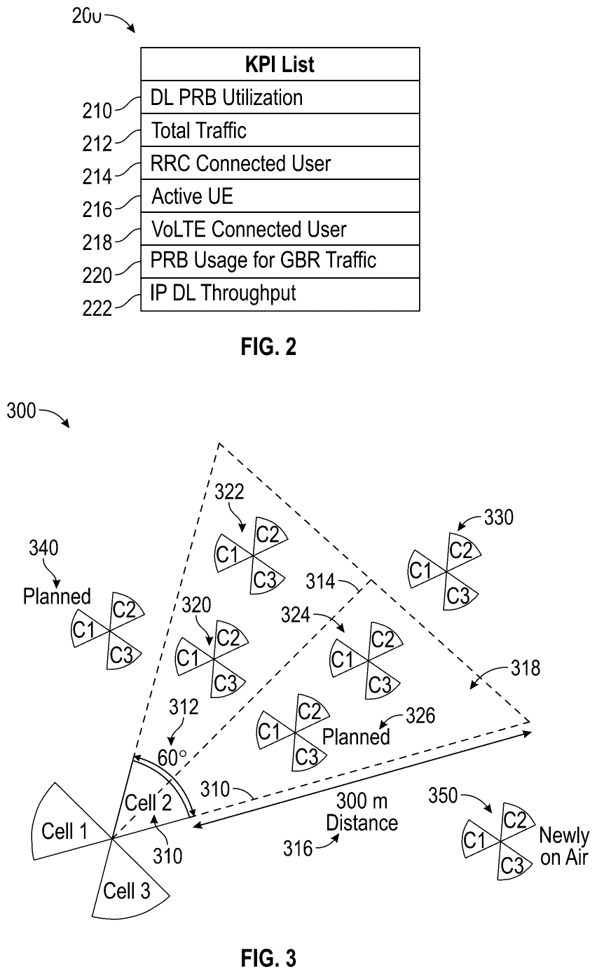

FIG. 2 illustrates a Key Performance Indicator (KPI) List 200 according to at least one embodiment.

In FIG. 2, the KPI List 200 associated with a cell site is gathered by a network management system. Multiple monitors gather the KPIs for identifying capacity issues for a cell site. The KPI List 200 is used to check KPIs which affect the capacity of a device and, by analyzing the KPI data, future usage is able to be predicted to identify suspected future capacity breaches.

KPI List 200 shows a Downlink (DL) Physical Resource Block (PRB) Utilization parameter 210, an indicator of Total Traffic 212, a Radio Resource Control (RRC) Connected User 214, identification of Active User Equipment (UE) 216, identification of Voice over Long-Term Evolution (VOLTE) Connected Users 218, an indication of PRB Usage for Guaranteed Bit Rate (GBR) Traffic 220, and a measurement of Internet Protocol (IP) DL Throughput 222.

DL PRB Utilization 210 shows the average value of the PRB utilization per TTI (Transmission Time Interval) in downlink direction. The utilization is defined by the ratio of used to available PRBs per TTI. DL PRB Utilization 210 is used to manage the quality of service (QOS). Total Traffic 212 is a measurement of the total amount of data messages received or transmitted over a communication channel. RRC Connected User 214 is a measurement of the total number of users connected to an RRC. Active UE 216 is the total number of active users that are currently connected to the network where data is being sent or communication is taking place. VOLTE Connected Users 218 is a measurement of the number of users connected to VOLTE (Voice over Long-Term Evolution). PRB Usage for GBR Traffic 220 is a measurement of usage of wireless resources of each cell for GBR traffic. IP DL Throughput 222 is a measurement of IP protocol-specific DL throughput for the cell site.

The KPI List 2000 is used forecast device capacity to identify future challenges for a network due to capacity breaches. Capacity of any network is the key to the performance, and if not managed properly network problems occur. A device according to at least one embodiment helps to predict capacity breaches of a network device in future, predetermined windows and helps to reduce the number of problems in a network due to capacity breaches.

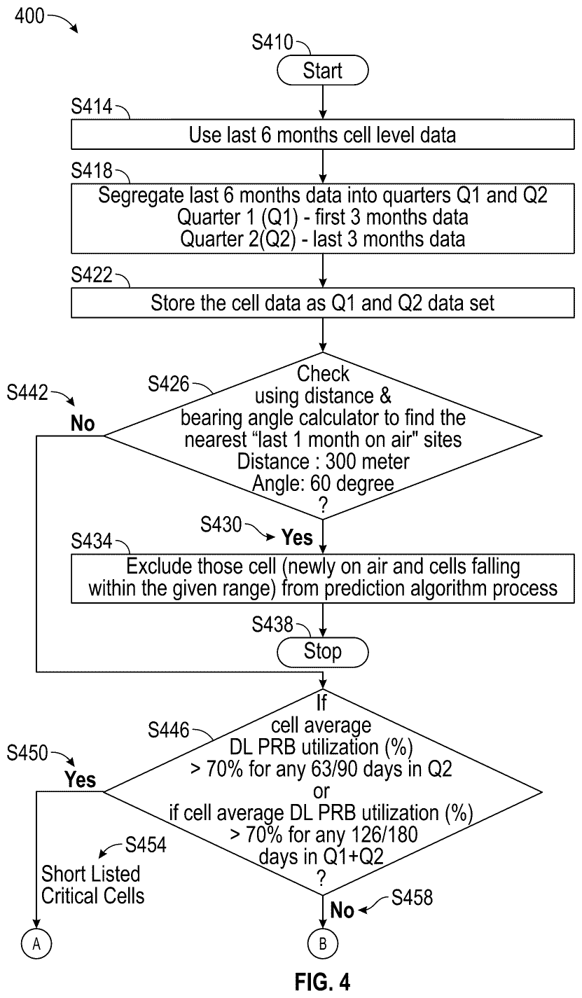

FIG. 3 illustrates Bearing And Angle Calculation 300 according to at least one embodiment.

In FIG. 3, Cell 310 is shown pointing is a particular direction. The azimuth angle is based on a 60 degree beamwidth angle 312, 30 degrees to each side of the center of the beam 314. A predetermined distance, e.g., 300 meter 314, for a radius using a step size of 2 degrees. The step size means refers to how much distance (in meters) are to be plotted to draw a boundary. For example, to draw a circle data points are to be kept as close as possible for better accuracy. By using two large of a step size or too large of a distance, the accuracy for forming a circle is lost. The predetermined distance is set so the beam 314 captures everything all the way up to 300 meters 316 within the azimuth of 60 degrees 312. If no cell sites are found within the area 318, the area is expanded, e.g., the range of 300 meters 314 may be increased. Neighboring Cell Sites are determined relative to an area 318 defined by the azimuth 312 and 300 meters 316. In FIG. 3, Cell Sites 320, 322, 324, 326 lie within the area 318. Cells not in range of 300 meters 316 and outside the angle 312 are identified, e.g., Cell Site 330, Planned Cell Site 340, and Newly On Air Cell Site 350 lie outside area 318.

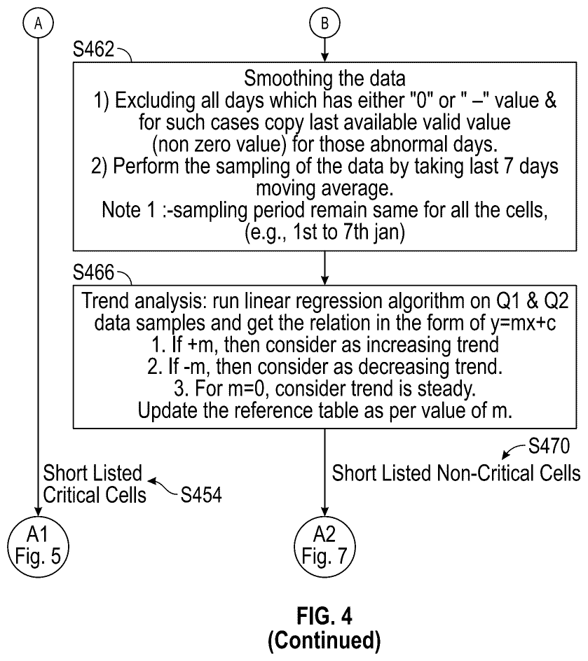

FIG. 4 a flowchart 400 of a method for identifying Critical Cells and Non-Critical Cells 400 according to at least one embodiment.

In FIG. 4, process starts S410 and the past six months data for KPIs are obtained from a KPI list S414.

The data is segregated into a first historical time window, e.g., Q1 (first three months of historical data) and a more recent historical time window, e.g., Q2 (the last three months of historical data) S418. The Q1 data and Q2 data are stored S422.

Using a Distance and Bearing Angle Calculation, determine nearest “last 1 month On Air” cell sites within an area defined by a distance of 300 meters and an azimuth angle of 60 degrees S426. In response to Distance and Bearing Angle Calculation being “Yes” S430, the “Last 1 month On Air” cell sites located within the area defined by a distance of 300 meters and an azimuth angle of 60 degrees S430, are excluded S434. The process then stops S438.

In response to Distance and Bearing Angle Calculation being “No” S442, identify whether cells meet a criteria for critical cells S446. The KPIs are checked to determine whether a predetermined KPI meets a threshold criteria during a most recent predetermined time window, e.g., DL PRB is more than 70% for any 63 days out of 90 days in Q2, and during a longer predetermined historical time window, e.g., DL PRB is more than 70% for any 126 days out of 180 days in Q1 and Q2. Those skilled in the art understand that months, days, and quarters are used to describe at least one embodiment herein, but other time frames or windows are able to be used.

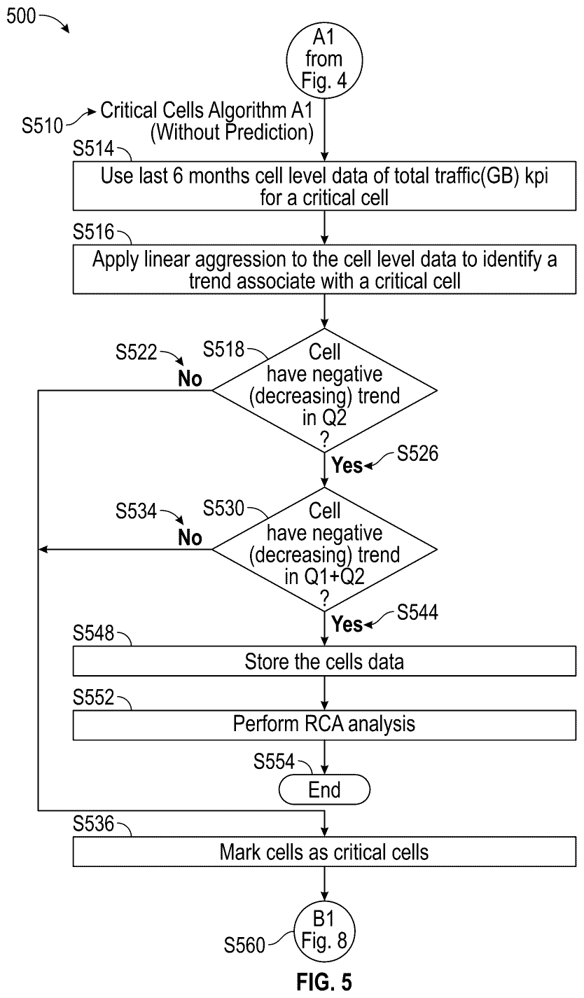

In response to identifying cells that breach condition S450, these cells are listed as critical cells sites and are considered for immediate expansion S454. Critical cells have a high utilization and the cells are considered for capacity increase actions and the process continues at A1 in FIG. 5.

In response to cells not meeting the criteria for critical cells S458, the data is smoothed S462. The data is smoothed to remove the seasonality and noise from the data. In at least one embodiment, a moving average technique is used to smooth the data. A moving average is calculated by adding up all the data points during a specific period and the sum is divided by the number of time periods. For abnormal days, where data is not present due to any reason, the pervious valid value will be considered for that day. For example, where a cell site is not radiating, the cell site was decommissioned on that day, or for that particular day data is not received from the device due to any reason, a hyphen (-) value is received. A zero (0) value is due to a tilt change in CM parameter, wherein the KPI data gets downgraded, and a zero (0) value is entered. The days which have zero (0) or hyphen (-) values, the last available non-zero value for those abnormal days will be considered. Thus, days which have either “0” or “-” value have the last data available copied into values for those days. Sampling of the data is performed by taking the last 7 days moving average. The sampling period remain same for all the cells, e.g., 1st to 7th of January.

Linear regression is then run on Q1 and Q2 data samples and the slope is obtained to identify a trend S466.

In at least one embodiment, the slope is calculated according to:

$$r = \frac{\sum ( X - \overline{X} ) ( Y - \overline{Y} )}{\sqrt{\sum {( X - \overline{X} )}^{2} \sqrt{{( Y - \overline{Y} )}^{2}}}} ,$$

where

X̅=mean of X variable, and Y̅=mean of Y variable.

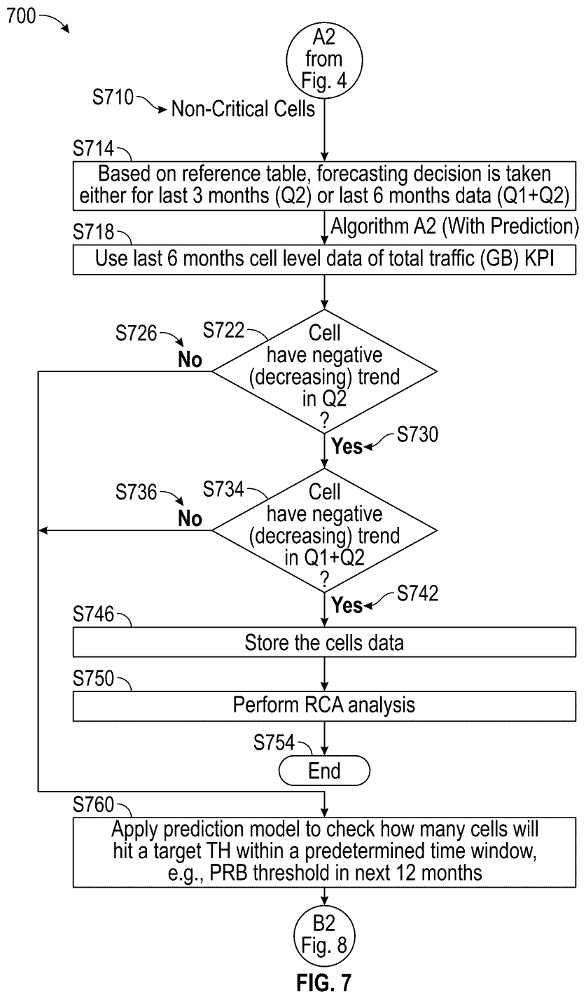

The slope is based on the equation of a line, y=mx+c, produced by applying linear regression to Q1 and Q2 data samples. This data set will have non-critical cells for which a forecast model will be applied to forecast the data. In response to a positive slope (+m), then the trend is considered to be an increasing trend. In response to a negative slope, (−m), then the trend is considered to be a decreasing trend. In response to the slope being steady, (m=0), then the trend is considered to be steady. The Reference Table is updated per the value of m. These cell sites are short listed as non-critical cells S470 and the process continues at A2 in FIG. 7.

FIG. 5 is a flowchart 500 of a method for processing critical cells without prediction according to at least one embodiment.

In FIG. 5, the process continues from A1 of FIG. 4 and a list of critical cells are received S510. These cells are already identified as being critical cells and highly utilized so a prediction process is not applied. The last 6 months of cell level data of total traffic KPI is used to process the critical cells S514. Linear aggression is applied to the cell level data to identify a trend associate with a critical cell S516.

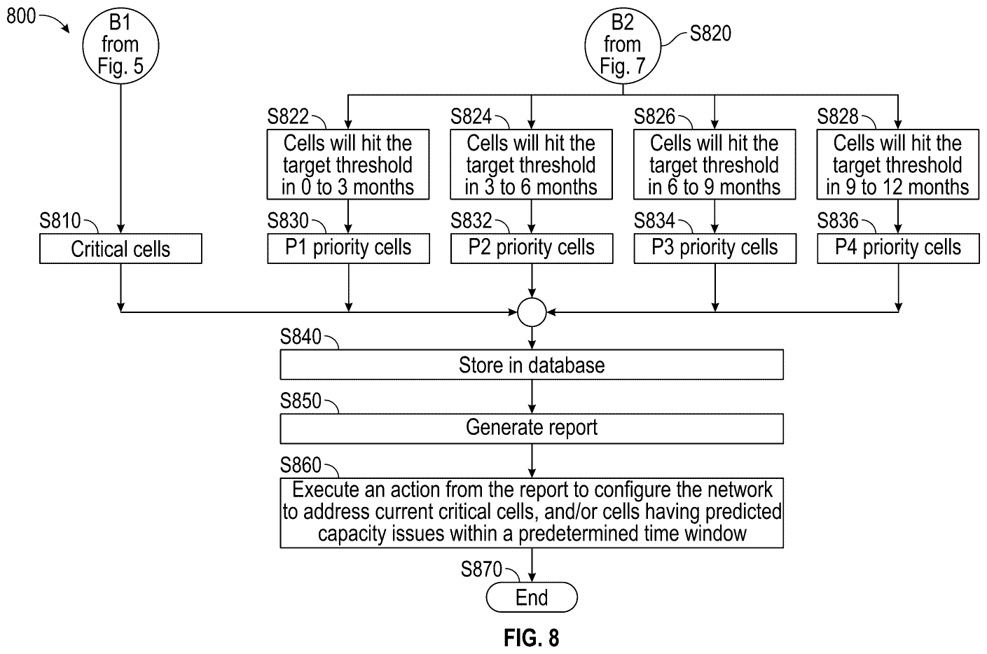

A determination is made whether the cells have a negative trend in Q2 S518. In response to the cells being determined to not have a negative trend in Q2 S522, the cells are marked as critical cells S536 and the process exits to B1 in FIG. 8 S560. In response to the cells being determined to have a negative trend in Q2 S526, a determination is made whether the cells have a negative trend in Q1+Q2 S530. In response to the cells being determined to not have a negative trend in Q1+Q2 S534, the cells are marked as critical cells S536 and the process exits to B1 in FIG. 8 S560. In response to the cells being determined to have a negative trend in Q1+Q2 S544, the cell data is stored S548 and RCA analysis is performed to determine the cause of the negative trend in Q1+Q2 S552. For example, the number of users within the region served by a cell site are determined to have moved to the area and the trend is a long lasting trend. Alternatively, the number of users are determined to move to the area because of an event and the trend is considered to be a temporary trend. After the event ends, the utilization for the cell site again decreases and the trend becomes negative so the data is stored for later RCA analysis to determine the reason that the trend remains negative. The process then ends S554.

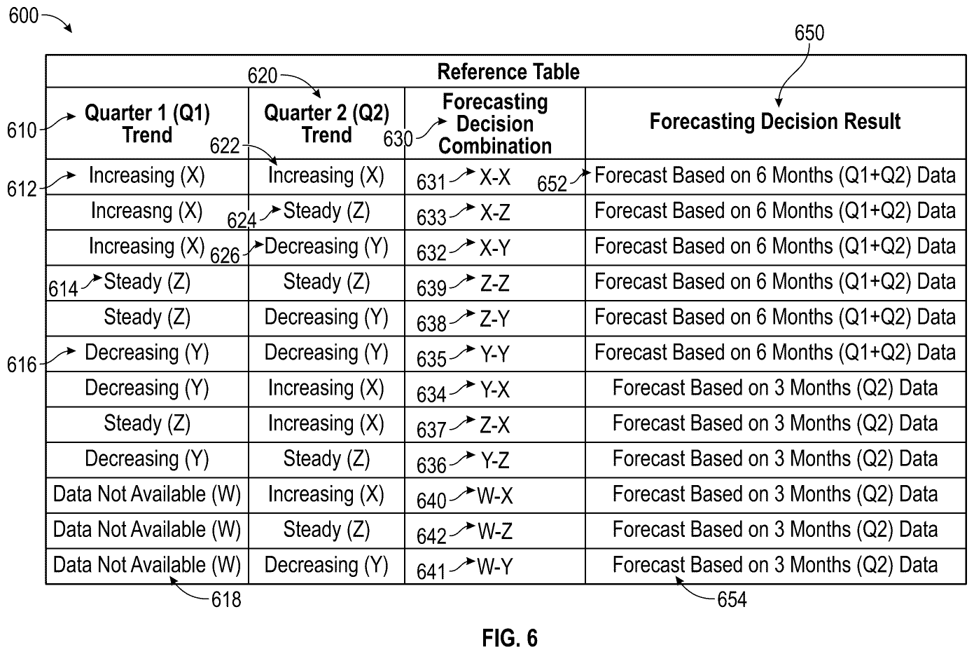

FIG. 6 illustrates a reference table 600 for determining how to make a forecasting decision according to at least one embodiment.

In FIG. 6, a first column is provided for Q1 Trends 610. A second column is provided for Q2 Trends 620. Next, a column is provided for identifying Forecasting Decision Combinations 630. A column is provided for identifying the Forecasting Decision Result 650. In a first row the Q1 Trend 610 is Increasing (X) 612. The Q2 Trend is Increasing (X) 622. The Forecasting Decision Combination 630 s X-X 631. The Forecasting Decision Result is Forecast Based on 6 Months (Q1+Q2 Data 652. The Q1 Trend 610 is also able to be Steady (Z) 614, Decreasing (Y) 616, and Data Not Available (W) 618. The Q2 Trend 620 is also able to be Steady (Z) 624, and Decreasing (Y) 626. The Forecasting Decision Combinations 630 include X-Y 632, X-Z 633, Y-X 634, Y-Y 635. Y-Z 636, Z-X 637, Z-Y 638, Z-Z 639, W-X 640, W-Y 641, and W-Z 642. The Forecasting Decision Result 640 also includes Forecast Based on 3 Months (Q2) Data 654.

FIG. 7 a flowchart 700 of a method for processing non-critical cells with prediction according to at least one embodiment.

In FIG. 7, a list of non-critical cells are received S710. Based on a reference table (e.g., as shown in FIG. 6), a forecasting decision is made either for the last 3 months (Q2) or the last 6 months data (Q1+Q2) S714. The last 6 months of cell level data of total traffic KPI is used to process the critical cells S718.

A determination is made whether the cells have a negative trend in Q2 S722. In response to the cells being determined to not have a negative trend in Q2 S726, the process loops to perform prediction to determine how many cells will hit the target PRB threshold in the next 12 months S760. Planned cell data and neighbor cell data are taken into consideration in forecasting results for cells so that the forecast result are improved and better accuracy is provided. The forecast enables the number of problems to be reduced due to network capacity and better service is able to be provided to users. The process then exits to B2 in FIG. 8.

In response to the cells being determined to have a negative trend in Q2 S730, a determination is made whether the cells have a negative trend in Q1+Q2 S734. In response to the cells being determined to not have a negative trend in Q1+Q2 S736, the process loops to apply a prediction model to determine how many cells will hit the target PRB threshold in the next 12 months S760. Planned cell data and neighbor cell data are taken into consideration in forecasting results for cells so that the forecast result are improved and better accuracy is provided. The forecast enables the number of problems to be reduced due to network capacity and better service is able to be provided to users. The process then exits to B2 in FIG. 8.

In at least one embodiment a Seasonal AutoRegressive Integrated Moving Average (SARIMA) prediction model is used to forecast the cell KPI and determine dates at which cells breach the threshold (e.g., DL PRB is more than 70%) value. The SARIMA model supports univariate time series data with a seasonal component. The SARIMA model adds three hyperparameters to specify the autoregression (AR), differencing (I) and moving average (MA) for the seasonal component of the series, as well as an additional parameter for the period of the seasonality. To configure SARIMA the trend and seasonal element of the series are set. The trend elements include p (trend autoregression order), d (trend difference order), and q (trend moving average order). There are four seasonal elements that are not part of ARIMA, which are configured for SARIMA. The four seasonal elements are P (seasonal autoregressive order), D (seasonal difference order), Q (seasonal moving average order), and m (the number of time steps for a single seasonal period). Together, the notation for a SARIMA model is specified as SARIMA (p, d, q)(P, D, Q) m. In at least one embodiment, the values for above parameters are p=0, d=1, q=0, P=1, D=1, Q=1, m=7, wherein m of 7 for daily data suggest a weekly seasonal cycle.

In response to the cells being determined to have a negative trend in Q1+Q2 S742, the cell data is stored S746 and RCA Analysis is performed to determine the cause of the negative trend in Q1+Q2 S750 regarding the reason the trend for the cell is negative. The process then ends S754.

FIG. 8 is a flowchart 800 of a method for executing an action for addressing identified capacity issues according to at least one embodiment

In FIG. 8, critical cells from B1 of FIG. 5 are received S810. The forecast of non-critical cells meeting a target threshold in predetermined forecast time windows is received from B2 of FIG. 7 S820. Cells are forecast as hitting the target threshold in a predetermined windows, such as 0 to 3 months S822, 3 to 6 months S824, 6 to 9 months S826, and 9 to 12 months S828. P1 Priority Cells S830 are forecast as hitting the target threshold in 0 to 3 months S822. P2 Priority Cells S832 are forecast as hitting the target threshold in 3 to 6 months S824. P3 Priority Cells S834 are forecast as hitting the target threshold in 6 to 9 months S826. P4 Priority Cells S836 are forecast as hitting the target threshold in 9 to 12 months S828. Those skilled in the art recognize that at least one embodiment is described using predetermined time windows of 0 to 3 months S822, 3 to 6 months S824, 6 to 9 months S826, and 9 to 12 months S828, but that other time frames may be used instead. In at least one embodiment, the predetermined time windows are configurable. In addition, those skilled in the art recognize that performing the prediction model on a daily based does not provide meaningful data because the critical cells have already been identified. Thus, the prediction model is applied using a longer cycle, such as a month, so that new critical cells with predicted high utilization in the future windows are identified.

Next the data for the critical cells and the non-critical cells are stored in a database S840. A report is automatically generated based on the data S850. Then, an action from the report is executed to configure the network to address at least one of current critical cells, and/or cells having predicted capacity issues within the predetermined time windows S860.

Those skilled in the art understand that the action from the report is able to be executed to configure the network to address current critical cells, cells having predicted capacity issues within the predetermined time windows, or both current critical cells and cells having predicted capacity issues within the predetermined time windows. Further, “an action from the report is executed to configure the network to address at least one of current critical cells, or cells having predicted capacity issues within the predetermined time windows” is understood to mean an action from the report is executed to configure the network to address current critical cells, cells having predicted capacity issues within the predetermined time windows, or both current critical cells and cells having predicted capacity issues within the predetermined time windows.

There are many methods to increase capacity for a cell site. In at least one embodiment, an action to address capacity issues includes expanding capability of a cell by increasing one or more of resources, bandwidth, antenna, etc. in critical cells and/or cells having predicted capacity issues within the predetermined time window, downgrading a non-critical cell by reducing one or more of resources, bandwidth, antenna, etc., decreasing a load on a cell, installing a new cell proximate to the critical cells and/or the cells having predicted capacity issues within the predetermined time window, changing routers and switches at a cell, upgrading the critical cells and/or the cells having predicted capacity issues within the predetermined time window from 3G to 4G and 5G, downgrading the critical cells and/or the cells having predicted capacity issues within the predetermined time window from 5G to 4G.

For example, LTE networks are significantly more spectrum-efficient than 3G in carrying mobile traffic. LTE is capable of even further improvements, e.g., LTE-Advanced (LTE-A or 4G+). These improvements divide into three categories: 1) increasing the raw transmission throughputs over LTE radio links; 2) further increasing the possibilities for spectrum reuse; and 3) packing offered traffic more efficiently into available transmission capacity.

LTE also implements higher-order Multiple Input Multiple Output (MIMO) implementations to provide increased traffic capacity. Some LTE deployments use 2×2 MIMO. This places two antennas at the base station and two antennas in the user device. Because of the slight physical displacement of each transmitting antenna from the other transmitting antenna(s) and of each receiving antenna from the other receiving antenna(s), each sent and received signal will be subject to different multipath characteristics. By examining the four signals together, more of the originally encoded information may be extracted. In addition, MIMO technology may be used to send multiple concurrent transmission streams between the base station and user device.

5G provides even more bandwidth, or capacity, than 4G. This is because 5G makes much more efficient use of the available spectrum. 4G uses a narrow slice of the available spectrum from 600 MHz to 2.5 GHz, but 5G is divided into three different bands. Each band has its own frequency range and speed, and will have different applications and use cases.

In at least one embodiment, the amount of data cells carry is able to be increased by dividing or splitting cells to reduce cell size, and thus increase the number of cells serving a given area. Cell splitting reduces congestion and interference by boosting the carrying capacity of a channel, enhance the availability and dependability of networks, and provide a greater degree of frequency reuse.

Splitting cells is implemented by deploying more radio towers/antennas and shrinking the reach of each tower by reducing the radiated power of its radio transmissions. This allows radio spectrum to be reused for multiple simultaneous transmissions within the geographic area. Thus, by subdividing cells, the amount of traffic that the spectrum can carry within an overall geographic area is increased. Each cell is able to utilize its own base station, and a reduction in antenna height and transmitter power may also be implemented.

Cell sectoring is another technique that is used to boost capacity. In cell sectoring, each cell is subdivided into radial sectors with directional BS antennas in order to improve the performance of the system in order to combat the interference caused by co-channels. A number of sectored antennas are mounted on a single microwave tower that is situated in the middle of the cell, and a following number of antennas are installed to cover the 360-degree area of the cell. During the process of cell sectoring, the number of cells that make up a particular cluster is reduced, and the distance that separates co-channels is also brought closer together. Therefore, cell sectoring reduces co-channel interference in order to boost the capacity of the cellular system.

The above represent just a few examples of actions that can be executed to increase capacity for a cell. Those skilled in the art recognize that other methods, either existing or future developed technology and methods, are able to be utilized without departing from the scope of embodiments described herein. Also, operators are also able to change technology or methods in response to a cell showing a negative trend.

After the report is generated S850 and an action is executed to address capacity issues S860, the process then ends S870. For example, a user can download a report for all cells that are currently highly utilized or will be highly utilized in the near future (within predetermined time windows), and based on the report, the user is able to execute an action, such as planning and installing a new site in the area to improve network coverage. KPIs data is also visible on a dashboard for monitoring purpose. A user is also able to run other processes or use other tools based on the analysis provided in the report to determine coverage in an area. Statistical analysis is able to be performed for obtaining a deeper insight about capacity utilization of cells in the network.

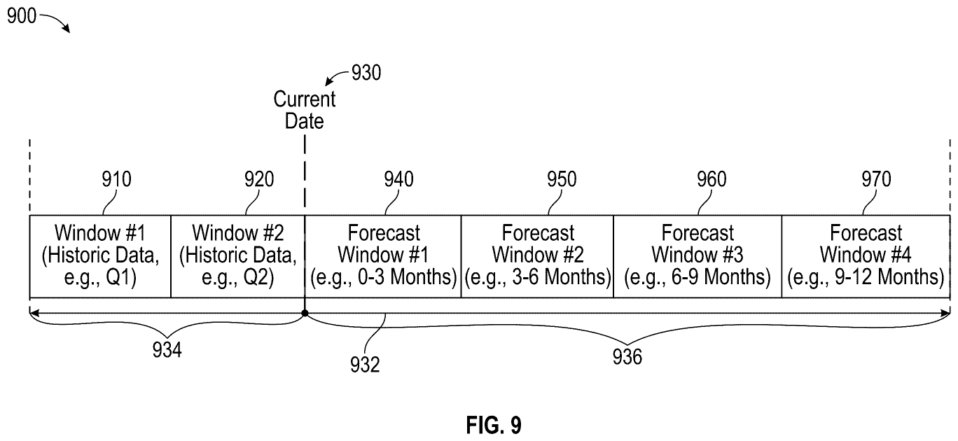

FIG. 9 illustrates predetermined forecast windows 900 according to at least one embodiment.

In FIG. 9, as described above, forecasts are made on historical data that is obtained from one or more of a first historical data window, e.g., Q2 910, and a second historical data window, e.g., Q1 920, relative to a current date 930. A timeline 932 shows the historical time frame 934 and the forecast time frame 936. Forecasts are made based on the one or more of the first historical data window 920 and second historical data window 920. The forecasts are made for predetermined forecast windows relative to the current date 930, e.g., 0-3 months 940, 3-6 months 950, 6-9 months 960, and 9-12 months 970. While the three month windows are used for illustrations, in at least one embodiment the window lengths have a different length, e.g., 2 month, 4 months, etc.

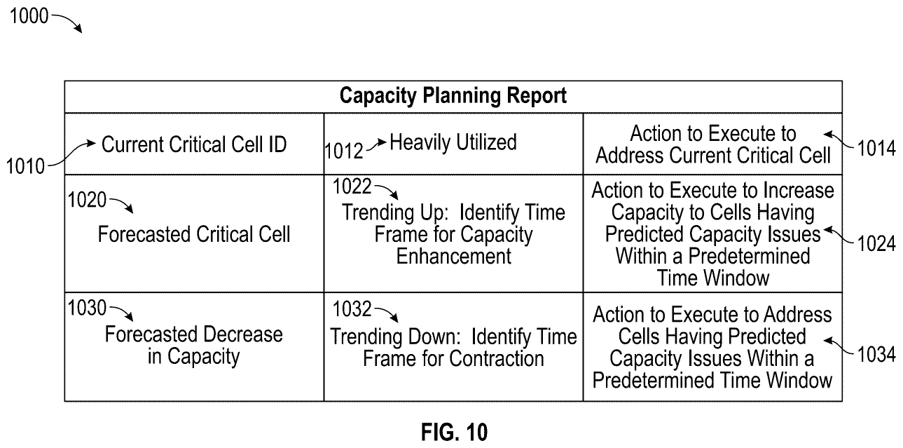

FIG. 10 illustrates a capacity planning report 1000 according to at least one embodiment.

In FIG. 10, the capacity planning report 1000 includes a Current Critical Cell Identifier (ID) 1010. The Current Critical Cell 1010 is identified as being Heavily Utilized 1012. An Action is listed in the report to execute to address the current critical cell 1014.

The report also includes a Forecasted Critical Cell 1020. Forecasted Critical Cell 1020 is shown as “Trending Up: Identify Time Frame For Capacity Enhancement” 1022. An Action is listed in the report to execute to address the cell having predicted capacity issues within a predetermined time window (to increase capacity of forecasted critical cell (from non-critical cells within the predetermined time window) 1024.

FIG. 10 also shows a cell that has Forecasted Decrease in Capacity 1030. The cell having a Decrease in Capacity 1030 is shown as “Trending Down: Identify Time Frame For Contraction” 1032. An Action is listed in the report to execute to address the cell having predicted capacity issues within a predetermined time window (to address decrease in capacity of the cell within the predetermined time window) 1034.

The location of demand can change over time, sometimes unexpectedly. Other technologies, such as full-fiber broadband and Wi-Fi, continue to advance and serve some of the same data use cases, which can affect demand over time.

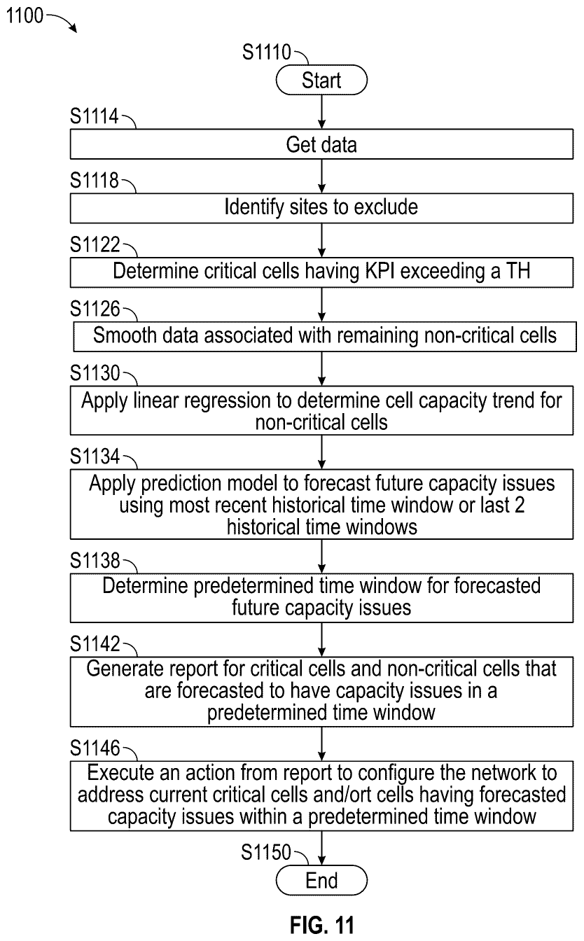

FIG. 11 is a flowchart 1100 of a method for forecasting capacity breaches in a mobile network according to at least one embodiment.

In FIG. 11, method starts S1110 and data associated with key performance indicators are obtained S1114. Referring to FIG. 2, multiple monitors gather the KPIs for identifying capacity issues for a cell site. The KPI List 200 is used to check KPIs which affect the capacity of a device and, by analyzing the KPI data, future usage is able to be predicted to identify suspected future capacity breaches. KPI List 200 shows a Downlink (DL) Physical Resource Block (PRB) Utilization parameter 210, an indicator of Total Traffic 212, a Radio Resource Control (RRC) Connected User 214, identification of Active User Equipment (UE) 216, identification of Voice over Long-Term Evolution (VOLTE) Connected Users 218, an indication of PRB Usage for Guaranteed Bit Rate (GBR) Traffic 220, and a measurement of Internet Protocol (IP) DL Throughput 222.

Sites to exclude are identified S1118. Referring to FIG. 4, for example, in response to Distance and Bearing Angle Calculation being “Yes” S430, the “Last 1 month On Air” cell sites located within the area defined by a distance of 300 meters and an azimuth angle of 60 degrees S430, are excluded S434. Critical cells having a predetermined KPI exceeding a threshold are determined S1122.

For remaining non-critical cells, process the data to smooth the data S1126. Referring to FIG. 4, To smooth the data, the days which has zero (0) or hyphen (-) values are removed, wherein the last available non-zero value for those abnormal days will be considered. Thus, days which have either “0” or “-” value have the last data available copied into values for those days. Sampling of the data is performed by taking the last 7 days moving average. The sampling period remain same for all the cells, e.g., 1st to 7th January.

Linear Regression is applied to determine a cell capacity trend for the non-critical cells S1130. Referring to FIG. 4, the slope is based on the equation of a line, y=mx+c, produced by applying linear regression to Q1 and Q2 data samples. This data set will have noncritical cells for which a forecast model will be applied to forecast the data. In response to a positive slope (+m), then the trend is considered as increasing trend. In response to a negative slope, (−m), then the trend is considered a decreasing trend. In response to the slope being steady, (m=0), then the trend is considered steady. The Reference Table is updated per the value of m. Those skilled in the art understand that months, days, and quarters are used herein to describe at least one embodiment, but other time frames or windows are able to be used.

A prediction model is applied to forecast future capacity issues using most recent historical time window or last two most recent historical time windows S1134. Referring to FIG. 7, planned cell data and neighbor cell data are taken into consideration in forecasting results for cells so that the forecast result are improved and better accuracy is provided. The forecast enables the number of problems to be reduced due to network capacity and better service is able to be provided to users.

A predetermined time window is determined for forecasting further capacity issues S1138. For example, referring to FIG. 7, prediction is performed to determine how many cells will hit a target TH within a predetermined time window S760, e.g., PRB threshold in the next 12 months. Referring to FIG. 8, Cells are forecast as hitting the target threshold in a predetermined windows, such as 0 to 3 months S822, 3 to 6 months S824, 6 to 9 months S826, and 9 to 12 months S828. Those skilled in the art recognize that at least one embodiment is described using predetermined time windows of 0 to 3 months S822, 3 to 6 months S824, 6 to 9 months S826, and 9 to 12 months S828, but that additional time frames, fewer time frames, or time frames of different lengths may be used instead.

A report is generated for the critical cells and the non-critical cells that are forecasted to have a capacity issue in the predetermined time window S1142. Referring to FIG. 10, the capacity planning report 1000 includes a Current Critical Cell Identifier (ID) 1010. The Current Critical Cell 1010 is identified as being Heavily Utilized 1012. An Action 1014 is listed for addressing the current critical cell 1014. The report also includes a Forecasted Critical Cell 1020. Forecasted Critical Cell 1020 is shown as “Trending Up: Identify Time Frame For Capacity Enhancement” 1022. An Action 1024 is shown for execution to increase capacity to cells having predicted capacity issues within a predetermined time window. FIG. 10 also shows a cell that has Forecasted Decrease in Capacity 1030. The cell having a Decrease in Capacity 1030 is shown as “Trending Down: Identify Time Frame For Contraction” 1032. An Action 1024 is shown for execution to address the cell having predicted capacity issues within a predetermined time window.

An action from the report is executed to configure the network to address at least one of current critical cells, and/or cells having forecasted issues with a predetermined time window S1146. Referring to FIG. 8, based on the generated report, an action is executed to configure the network to address current critical cells and/or cells having predicted capacity issues within the predetermined time windows S860.

Those skilled in the art understand that the action from the report is able to be executed to configure the network to address current critical cells, cells having predicted capacity issues within the predetermined time windows, or both current critical cells and cells having predicted capacity issues within the predetermined time windows. Further, “an action from the report is executed to configure the network to address at least one of current critical cells, or cells having predicted capacity issues within the predetermined time windows” is understood to mean an action from the report is executed to configure the network to address current critical cells, cells having predicted capacity issues within the predetermined time windows, or both current critical cells and cells having predicted capacity issues within the predetermined time windows.

Further, as described above, there are many methods to increase capacity for a cell site. In at least one embodiment, an action to address capacity issues includes expanding capability of a cell by increasing at least one of resources and bandwidth in critical cells and cells having predicted capacity issues within the predetermined time window, downgrading a non-critical cell by reducing at least one of resources and bandwidth, decreasing a load on a cell, installing a new cell proximate to the critical cells and the cells having predicted capacity issues within the predetermined time window, changing routers and switches at a cell, upgrading the critical cells and the cells having predicted capacity issues within the predetermined time window from 3G to 4G and 5G, downgrading the critical cells and the cells having predicted capacity issues within the predetermined time window from 5G to 4G. The process then ends S1150.

At least one embodiment for forecasting capacity breaches in a mobile network includes accessing a Key Performance Indicators (KPI) database to obtain KPI data associated capacity of cells in a mobile network, based on the KPI data, identifying critical cells and non-critical cells, the critical cells exhibiting high utilization affecting performance by the critical cells, and the non-critical cells not exhibiting high utilization, for the non-critical cells, applying a prediction model to identify at least one predetermined forecast time window associated with capacity issues associated with at least one of the non-critical cells, based on the applying the prediction model, generating a report identifying at least one action to execute to configure the mobile network to address at least one of capacity issues of the critical cells, or capacity issues of the non-critical cells having forecasted capacity issues within one of the predetermined forecast time windows, and executing the at least one action to configure the mobile network to address the at least one of capacity issues of the critical cells, or capacity issues of the non-critical cells having forecasted capacity issues within one of the predetermined forecast time windows.

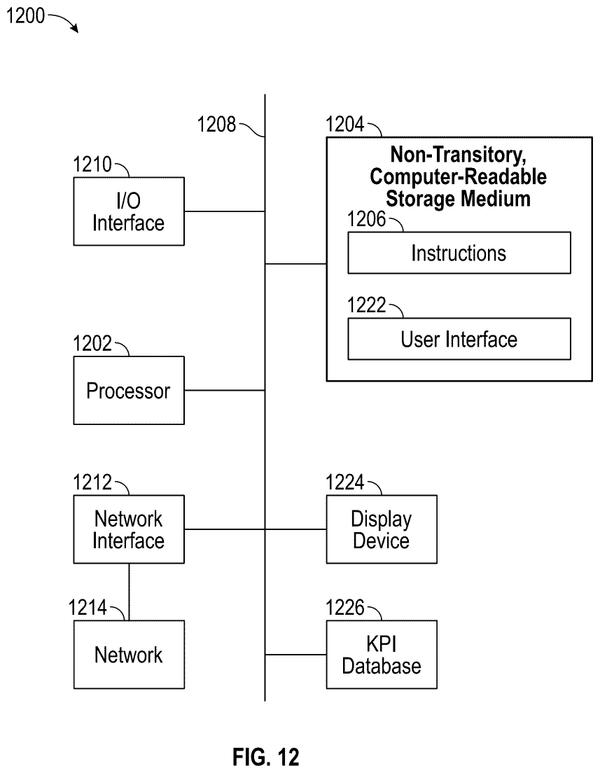

FIG. 12 is a high-level functional block diagram of a processor-based system 1200 according to at least one embodiment.

In at least one embodiment, Processing Circuitry 1200 links at least one subsequent and correlated alarm to a primary alarm. Processing Circuitry 1200 implements a method for forecasting capacity breaches in a mobile network using Processor 1202. Processing Circuitry 1200 also includes a Non-Transitory, Computer-Readable Storage Medium 1204 that is used to implement a method for forecasting capacity breaches in a mobile network. Storage Medium 1204, amongst other things, is encoded with, i.e., stores, Instructions 1206, i.e., computer program code that are executed by Processor 1202 causes Processor 1202 to perform operations for forecasting capacity breaches in a mobile network. Execution of Instructions 1206 by Processor 1202 represents (at least in part) an application which implements at least a portion of the methods described herein in accordance with one or more embodiments (hereinafter, the noted processes and/or methods). In at least one embodiment, Processing Circuity 1200 is a server, such as a cloud server, that accesses KPI Database 1226.

Processor 1202 is electrically coupled to computer-readable storage medium 1204 via a bus 1208. Processor 1202 is electrically coupled to an Input/Output (I/O) Interface 1210 by Bus 1208. A Network Interface 1212 is also electrically connected to Processor 1202 via Bus 1208. Network Interface 1212 is connected to a Network 1214, so that Processor 1202 and Computer-Readable Storage Medium 1204 connect to external elements via Network 1214. Processor 1202 is configured to execute instructions 1206 encoded in computer-readable storage medium 1204 to cause processing circuitry 1200 to be usable for performing at least a portion of the processes and/or methods. In one or more embodiments, Processor 1202 is a Central Processing Unit (CPU), a multi-processor, a distributed processing system, an Application Specific Integrated Circuit (ASIC), and/or a suitable processing unit.

Processing Circuitry 1200 includes I/O Interface 1210. I/O Interface 1210 is coupled to external circuitry. In one or more embodiments, I/O Interface 1210 includes a keyboard, keypad, mouse, trackball, trackpad, touchscreen, and/or cursor direction keys for communicating information and commands to Processor 1202.

Processing Circuitry 1200 also includes Network Interface 1212 coupled to Processor 1202. Network Interface 1212 allows processing circuitry 1200 to communicate with network 1214, to which one or more other computer systems are connected. Network Interface 1212 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 1264.

Processing Circuitry 1200 is configured to receive information through I/O Interface 1210. The information received through I/O Interface 1210 includes one or more of instructions, data, design rules, libraries of cells, and/or other parameters for processing by Processor 1202. The information is transferred to Processor 1202 via bus 1208. Processing Circuitry 1200 is configured to receive information related to a User Interface (UI) 1222 through I/O Interface 1210. The information is stored in Computer-Readable Medium 1204 as UI 1222. UI 1222 is presented on Display Device 1224 to forecast capacity breaches in a mobile network. KPI data is also presented on UI 1222 in a dashboard for monitoring the performance/capacity of cells. In at least one embodiment, a report is automatically displayed on UI 1222 by Display Device 1224 identifying at least one action to execute to address current critical cells, or cells having forecasted capacity issues within one a predetermined time window. Those skilled in the art understand that the action from the report is able to be executed to configure the network to address current critical cells, cells having predicted capacity issues within the predetermined time windows, or both current critical cells and cells having predicted capacity issues within the predetermined time windows. Further, “an action from the report is executed to configure the network to address at least one of current critical cells, or cells having predicted capacity issues within the predetermined time windows” is understood to mean an action from the report is executed to configure the network to address current critical cells, cells having predicted capacity issues within the predetermined time windows, or both current critical cells and cells having predicted capacity issues within the predetermined time windows.

In one or more embodiments, one or more non-transitory computer-readable storage media 1204 having stored thereon instructions (in compressed or uncompressed form) that are used to program a computer, processor, or other electronic device) to perform processes or methods described herein. The one or more non-transitory computer-readable storage media 1204 include one or more of an electronic storage medium, a magnetic storage medium, an optical storage medium, a quantum storage medium, or the like. For example, the computer-readable storage media includes, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 1204 includes a Compact Disk-Read Only Memory (CD-ROM), a Compact Disk-Read/Write (CD-R/W), and/or a Digital Video Disc (DVD).

In one or more embodiments, storage medium 1204 stores computer program code 1206 configured to cause processing circuitry 1200 to perform at least a portion of the processes and/or methods for providing subsequent and correlated alarm lists. In one or more embodiments, storage medium 1204 also stores information, such as algorithm which facilitates performing at least a portion of the processes and/or methods for forecasting capacity breaches in a mobile network. Accordingly, in at least one embodiment, the processor circuitry 1200 performs a method for forecasting capacity breaches in a mobile network.

The process includes accessing a Key Performance Indicators (KPI) database to obtain KPI data associated capacity of cells in a mobile network, based on the KPI data, identifying critical cells and non-critical cells, the critical cells exhibiting high utilization affecting performance by the critical cells, and the non-critical cells not exhibiting high utilization, for the non-critical cells, applying a prediction model to identify at least one predetermined forecast time window associated with capacity issues associated with at least one of the non-critical cells, and executing an action to configure the mobile network to address capacity issues of the critical cells and capacity issues of the non-critical cells having forecasted capacity issues within one of the predetermined forecast time windows.

The process for forecasting capacity breaches in a mobile network has the advantages of identifying cells that are going to be critical in the near future, reducing the capacity failures and network failures due to the current capacity load, improving network performance, proactively managing highly utilized cells, and identifying potential risks in network. Forecasting network capacity breaches in the future and helps to plan network expansion to avoid network failures due to capacity breaches.

In at least one embodiment, separate instances of these programs are executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above are able to be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for forecasting capacity breaches in a mobile network, comprising:
accessing a Key Performance Indicators (KPI) database to obtain KPI data associated capacity of cells in a mobile network;
based on the KPI data, identifying critical cells and non-critical cells, the critical cells exhibiting high utilization affecting performance by the critical cells, and the non-critical cells not exhibiting high utilization;
for the non-critical cells, applying a prediction model to identify at least one predetermined forecast time window associated with capacity issues associated with at least one of the non-critical cells;
based on the applying the prediction model, generating a report identifying at least one action to execute to configure the mobile network to address at least one of capacity issues of the critical cells, or capacity issues of the non-critical cells having forecasted capacity issues within one of the predetermined forecast time windows; and
executing the at least one action to configure the mobile network to address the at least one of capacity issues of the critical cells, or capacity issues of the non-critical cells having forecasted capacity issues within one of the predetermined forecast time windows.

2. The method of claim 1, wherein the accessing the KPI database to obtain KPI data associated with the capacity of the cells in the mobile network further includes obtaining KPI data for a first historical time window and a most recent historical time window, the first historical time window occurring immediately before the most recent historical time window.

3. The method of claim 1, wherein the identifying the critical cells includes:
determining cells within a predetermined area that are not newly On Air cells; and
identifying the cells within the predetermined area that are not newly On Air cells and that exceed a predetermined performance threshold based on the KPI data as the critical cells.

4. The method of claim 3, wherein the wherein the identifying the cells within the predetermined area that exceed the predetermined performance threshold based in the KPI data as the critical cells includes:
determining, for a first yearly quarter, an average downlink (DL) physical resource block (PRB) utilization exceeding 70% for 63 days out of 90 days in the first yearly quarter, or determining, for a two yearly quarter period, the average downlink (DL) physical resource block (PRB) utilization exceeding 70% for 126 days out of 180 days in the two yearly quarter period.

5. The method of claim 1, wherein the identifying the non-critical cells includes:
determining cells within a predetermined area that are not newly On Air cells;
identifying the cells within the predetermined area that are not newly On Air cells and that do not exceed a predetermined performance threshold based on the KPI data as the non-critical cells;
filling in invalid data values by copying a last available valid data for a day with invalid data values to generate adjusted data for the non-critical cells;
calculating a moving average for the adjusted data to generate averaged data for the non-critical cells; and
applying linear regression to the averaged data to identify a trend associated with the averaged data for the non-critical cell.

6. The method of claim 5, wherein the applying linear regression to the averaged data to identify the trend associated with the average data for the non-critical cells further includes:
determining whether the non-critical cells have a negative trend associated with the averaged data for the non-critical cells for an immediately previous yearly quarter;
in response to determining the non-critical cells have the negative trend associated with the averaged data for the non-critical cells for the immediately previous yearly quarter, determining whether the non-critical cells have the negative trend associated with the averaged data for the non-critical cells for an immediately previous two yearly quarters; and
in response to determining the non-critical cells have the negative trend associated with the averaged data for the non-critical cells for the immediately previous quarter and for the immediately previous two yearly quarters, saving the data associated with the non-critical cells and performing root cause analysis using the data to identify a reason for the negative trend for the immediately previous quarter and for the immediately previous two yearly quarters;
wherein the prediction model is applied to the non-critical cells to identify at least one predetermined forecast time window associated with capacity issues associated with at least one of the non-critical cells in response to determining the non-critical cells do not have the negative trend for the immediately previous quarter and for the immediately previous two yearly quarters.

7. The method of claim 1, wherein the applying the prediction model to identify the at least one predetermined forecast time window associated with the capacity issues associated with the at least one of the non-critical cells includes:
applying a Seasonal AutoRegressive Integrated Moving Average (SARIMA) prediction model to the at least one of the non-critical cells;
based on the applying the SARIMA prediction model to the at least one of the non-critical cells, identifying a first predetermined forecast window for capacity issues of the non-critical cells forecasted to occur in 0 to 3 months, a second predetermined forecast window for capacity issues of the non-critical cells forecasted to occur in 3 to 6 months, a third predetermined forecast window for capacity issues of the non-critical cells forecasted to occur in 6 to 9 months, and a fourth predetermined forecast window for capacity issues of the non-critical cells forecasted to occur in 9 to 12 months; and
applying a first priority to the non-critical cells forecasted to have capacity issues in 0 to 3 months, a second priority to the non-critical cells forecasted to have capacity issues in 3 to 6 months, a third priority to the non-critical cells forecasted to have capacity issues in 6 to 9 months, and a fourth priority to the non-critical cells forecasted to have capacity issues in 9 to 12 months.

8. The method of claim 1, wherein the identifying the critical cells includes:
determining whether the critical cells have a negative trend associated with the averaged data for the critical cells for an immediately previous yearly quarter,
in response to determining whether the critical cells have the negative trend associated with the averaged data for the critical cells for an immediately previous two yearly quarters, marking the critical cells;
in response to determining the critical cells have the negative trend associated with the averaged data for the critical cells for the immediately previous quarter and for the immediately previous two yearly quarters, saving the cell data associated with the critical cells and performing root cause analysis to identify a reason for the negative trend for the immediately previous quarter and for the immediately previous two yearly quarters; and
in response to determining the critical cells have the negative trend associated with the averaged data for the critical cells for the immediately previous quarter and for the immediately previous two yearly quarters, marking the critical cells.

9. A device for forecasting capacity breaches in a mobile network, comprising:
a memory storing computer-readable instructions; and
a processor configured to execute the computer-readable instructions to:
access a Key Performance Indicators (KPI) database to obtain KPI data associated capacity of cells in a mobile network;
based on the KPI data, identify critical cells and non-critical cells, the critical cells exhibiting high utilization affecting performance by the critical cells, and the non-critical cells not exhibiting high utilization;
for the non-critical cells, apply a prediction model to identify at least one predetermined forecast time window associated with capacity issues associated with at least one of the non-critical cells; and
based on applying the prediction model, generate a report identifying an action to execute to configure the mobile network to address at least one of capacity issues of the critical cells, or capacity issues of the non-critical cells having forecasted capacity issues within one of the predetermined forecast time windows.

10. The device of claim 9, wherein the processor accesses the KPI database to obtain KPI data associated with the capacity of the cells in the mobile network by obtaining KPI data for a first historical time window and a most recent historical time window, the first historical time window occurring immediately before the most recent historical time window.

11. The device of claim 9, wherein the processor identifies the critical cells by:
determining cells within a predetermined area that are not newly On Air cells; and
identifying the cells within the predetermined area that are not newly On Air cells and that exceed a predetermined performance threshold based on the KPI data as the critical cells, wherein the identifying the cells within the predetermined area that exceed the predetermined performance threshold based in the KPI data as the critical cells includes determining, for a first yearly quarter, an average downlink (DL) physical resource block (PRB) utilization exceeding 70% for 63 days out of 90 days in the first yearly quarter, or determining, for a two yearly quarter period, the average downlink (DL) physical resource block (PRB) utilization exceeding 70% for 126 days out of 180 days in the two yearly quarter period.

12. The device of claim 9, wherein the processor identifies the non-critical cells by:
determining cells within a predetermined area that are not newly On Air cells;
identifying the cells within the predetermined area that are not newly On Air cells and that do not exceed a predetermined performance threshold based on the KPI data as the non-critical cells;
filling in invalid data values by copying a last available valid data for a day with invalid data values to generate adjusted data for the non-critical cells;
calculating a moving average for the adjusted data to generate averaged data for the non-critical cells; and
applying linear regression to the averaged data to identify a trend associated with the averaged data for the non-critical cell.

13. The device of claim 9, wherein the processor applies the prediction model to identify the at least one predetermined forecast time window associated with the capacity issues associated with the at least one of the non-critical cells by:
applying a Seasonal AutoRegressive Integrated Moving Average (SARIMA) prediction model to the at least one of the non-critical cells;
based on the applying the SARIMA prediction model to the at least one of the non-critical cells, identifying a first predetermined forecast window for capacity issues of the non-critical cells forecasted to occur in 0 to 3 months, a second predetermined forecast window for capacity issues of the non-critical cells forecasted to occur in 3 to 6 months, a third predetermined forecast window for capacity issues of the non-critical cells forecasted to occur in 6 to 9 months, and a fourth predetermined forecast window for capacity issues of the non-critical cells forecasted to occur in 9 to 12 months; and
applying a first priority to the non-critical cells forecasted to have capacity issues in 0 to 3 months, a second priority to the non-critical cells forecasted to have capacity issues in 3 to 6 months, a third priority to the non-critical cells forecasted to have capacity issues in 6 to 9 months, and a fourth priority to the non-critical cells forecasted to have capacity issues in 9 to 12 months.

14. The device of claim 9, wherein the processor identifies the critical cells by:
determining whether the critical cells have a negative trend associated with the averaged data for the critical cells for an immediately previous yearly quarter,
in response to determining whether the critical cells have the negative trend associated with the averaged data for the critical cells for an immediately previous two yearly quarters, marking the critical cells;
in response to determining the critical cells have the negative trend associated with the averaged data for the critical cells for the immediately previous quarter and for the immediately previous two yearly quarters, saving the cell data associated with the critical cells and performing root cause analysis to identify a reason for the negative trend for the immediately previous quarter and for the immediately previous two yearly quarters; and
in response to determining the critical cells have the negative trend associated with the averaged data for the critical cells for the immediately previous quarter and for the immediately previous two yearly quarters, marking the critical cells.

15. A non-transitory computer-readable media having computer-readable instructions stored thereon, which when executed by a processor causes the processor to perform operations comprising:
accessing a Key Performance Indicators (KPI) database to obtain KPI data associated capacity of cells in a mobile network;
based on the KPI data, identifying critical cells and non-critical cells, the critical cells exhibiting high utilization affecting performance by the critical cells, and the non-critical cells not exhibiting high utilization;
for the non-critical cells, applying a prediction model to identify at least one predetermined forecast time window associated with capacity issues associated with at least one of the non-critical cells;
based on the applying the prediction model, generating a report identifying at least one action to execute to configure the mobile network to address at least one of capacity issues of the critical cells, or capacity issues of the non-critical cells having forecasted capacity issues within one of the predetermined forecast time windows; and
executing the at least one action to configure the mobile network to address the at least one of capacity issues of the critical cells, or capacity issues of the non-critical cells having forecasted capacity issues within one of the predetermined forecast time windows.

16. The non-transitory computer-readable media of claim 15, wherein the accessing the KPI database to obtain KPI data associated with the capacity of the cells in the mobile network further includes obtaining KPI data for a first historical time window and a most recent historical time window, the first historical time window occurring immediately before the most recent historical time window.

17. The non-transitory computer-readable media of claim 15, wherein the identifying the critical cells includes:
determining cells within a predetermined area that are not newly On Air cells; and
identifying the cells within the predetermined area that are not newly On Air cells and that exceed a predetermined performance threshold based on the KPI data as the critical cells.

18. The non-transitory computer-readable media of claim 15, wherein the identifying the non-critical cells includes:
determining cells within a predetermined area that are not newly On Air cells;
identifying the cells within the predetermined area that are not newly On Air cells and that do not exceed a predetermined performance threshold based on the KPI data as the non-critical cells;
filling in invalid data values by copying a last available valid data for a day with invalid data values to generate adjusted data for the non-critical cells;
calculating a moving average for the adjusted data to generate averaged data for the non-critical cells; and
applying linear regression to the averaged data to identify a trend associated with the averaged data for the non-critical cell.

19. The non-transitory computer-readable media of claim 15, wherein the applying the prediction model to identify the at least one predetermined forecast time window associated with the capacity issues associated with the at least one of the non-critical cells includes:
applying a Seasonal AutoRegressive Integrated Moving Average (SARIMA) prediction model to the at least one of the non-critical cells;
based on the applying the SARIMA prediction model to the at least one of the non-critical cells, identifying a first predetermined forecast window for capacity issues of the non-critical cells forecasted to occur in 0 to 3 months, a second predetermined forecast window for capacity issues of the non-critical cells forecasted to occur in 3 to 6 months, a third predetermined forecast window for capacity issues of the non-critical cells forecasted to occur in 6 to 9 months, and a fourth predetermined forecast window for capacity issues of the non-critical cells forecasted to occur in 9 to 12 months; and
applying a first priority to the non-critical cells forecasted to have capacity issues in 0 to 3 months, a second priority to the non-critical cells forecasted to have capacity issues in 3 to 6 months, a third priority to the non-critical cells forecasted to have capacity issues in 6 to 9 months, and a fourth priority to the non-critical cells forecasted to have capacity issues in 9 to 12 months.

20. The non-transitory computer-readable media of claim 15, wherein the identifying the critical cells includes:
determining whether the critical cells have a negative trend associated with the averaged data for the critical cells for an immediately previous yearly quarter,
in response to determining whether the critical cells have the negative trend associated with the averaged data for the critical cells for an immediately previous two yearly quarters, marking the critical cells;
in response to determining the critical cells have the negative trend associated with the averaged data for the critical cells for the immediately previous quarter and for the immediately previous two yearly quarters, saving the cell data associated with the critical cells and performing root cause analysis to identify a reason for the negative trend for the immediately previous quarter and for the immediately previous two yearly quarters; and
in response to determining the critical cells have the negative trend associated with the averaged data for the critical cells for the immediately previous quarter and for the immediately previous two yearly quarters, marking the critical cells.
